(19) United States
(12) Patent Application Publication
(10) Pub. No.: US 2009/0222460 A1
(43) Pub. Date: Sep. 3, 2009

(54) METHOD FOR DYNAMIC MANAGEMENT OF A DATABASE

(75) Inventors: Alain Leclercq, Monaco (MC); Yves Arnail, Belmont Sur Rance (FR); Bernard Delbourg, Montpellier (FR); Pierre Rabischong, Montpellier (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MEDISCS SARL, Castelnau le Lez (FR)

(21) Appl. No.: 11/908,898

(22) PCT Filed: Mar. 20, 2006
(86) PCT No.: PCT/FR06/50238

§ 371 Date: Jun. 10, 2008

(30) Foreign Application Priority Data
Mar. 18, 2005 (FR) 0550698

(51) Int. Cl. G06F 17/30; G06F 12/02

(52) U.S. Cl. 707/100; 707/200; 711/171; 707/E17.005; 711/E12.002; 707/E17.044

(57) ABSTRACT

The invention concerns a method for dynamic management of a database, wherein the data, stored in storage means, are designed to be ordered through ordering means according to at least one database structure comprising at least one field for receiving at least one data. The invention is characterized in that it consists in declaring, through information means, a field of said structure based on the characteristics of said data as said data are being introduced.

### BACKGROUND OF THE INVENTION

(1) Field of the Invention

This invention concerns a method for dynamic management of a database, in which data, stored in storage means, are designed to be ordered through ordering means according to at least one database structure comprising at least one field for receiving at least one datum, characterized in that it consists in declaring, through information means, a field of said structure based on the characteristics of said data as said data are being introduced.

This invention relates to the field of database-management systems.

The invention concerns in particular the dynamic management of a database.

As it is well-known, a database stores and organizes data in a structured manner. The access for a user to the data stored and ordered in the database occurs through a system for management of such a database. This system is aimed at permitting access to said data and their manipulation in the database, namely the insertion, the deletion or the modification of the data. Generally, a system for management of a database includes, on the one hand, a file manager for the storage of the data on a physical medium, on the other hand, an internal manager for ordering the data, and also an external manager used as a user interface.

(2) Description of the Prior Art

The state-of-the-art databases include a structure one should declare before the insertion of the data and in which data are classified based on fields defined according to the type and characteristics of said data, for example the type, the character-string length or the like. It is therefore necessary to allocate memory space to each field defined in said structure. This allocation is made definitively at the moment of creating the database by means of declaring its structure including the tables and fields relative thereto.

A disadvantage of the state-of-the-art databases and database managers resides in that said memory space is allocated, even if the field of the structure is not filled in. In fact, the creation of a field involves allocation of the memory space required for the latter and therefore a loss of space if the data that should be stored therein has no value or does not exist.

For example, a structure includes the fields corresponding to last name, first/middle name and address of a person, and is declared as such. If during the insertion of data, the address of a person is not known, the memory space will nevertheless be allocated in the structure. In other words, a superfluous quantity of memory is reserved and, hence, used during subsequent recording, at the physical level, of said database.

In addition, the creation of temporary fields requires allocation of memory that should be foreseen during the declaration of the structure and that should be deleted after its use. These operations slow down considerably the operation of a management system, so they are rarely contemplated.

### SUMMARY OF THE INVENTION

The object of the invention is to cope with the disadvantages of the state of the art by providing a dynamic management of a database, avoiding thus the reservation and the allocation of memory for a field if the latter is not filled in.

In addition, the dynamic management of the database according to the invention permits temporary creation of fields without burdening the operation of the management system.

Finally, the invention offers the possibility of recording only modifications brought to a database in the form of an update and on a non-rewritable medium, for example a memory of the type <<flash>>, ROM or equivalent.

To this end, this invention concerns a method for dynamic management of a database, in which data, stored in storage means, are designed to be ordered through ordering means according to at least one database structure comprising at least one field for receiving at least one datum, characterized in that it consists in declaring, through information means, a field of said structure based on the characteristics of said data as said data are being introduced.

According to other features of the invention, such a method consists in calculating the memory space to be allocated to a field according to the type, size or format of the data that is introduced therein.

Preferably, it consists in accessing a non-declared field of said structure through means for controlling said field generating a reply corresponding to a declared field without any data being introduced therein.

In addition, it consists in temporarily declaring a field of said structure.

In particular, it consists in saving all or part of the structure declared in the form of at least one original file accompanied or not by at least one update file.

Preferably, it consists in saving all or part of the structure declared, in particular in the form of several incremental update files.

According to an embodiment, it consists in saving the declared structure on removable and/or non-rewritable memory storage means.

Further features and advantages of the invention will become clear through the following detailed description of non-restrictive embodiments of the invention, with reference to the attached figures.

### BRIEF DESCRIPTION OF THE DRAWINGS

FIG. 1 is a schematic view of the memory space required for the insertion of data into a previously declared structure; and

FIG. 2 is a schematic representation of the memory space allocated according to the invention.

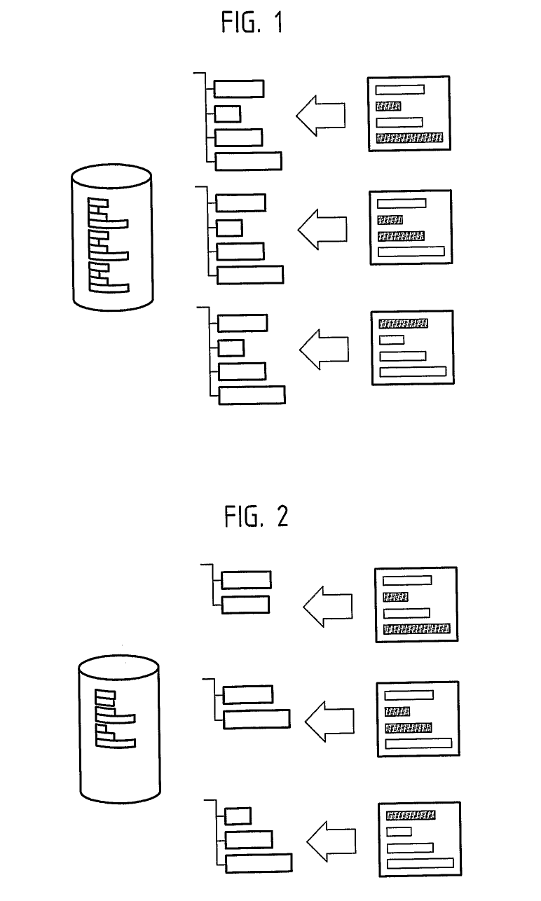

### DETAILED DESCRIPTION OF THE PREFERRED EMBODIMENTS

This invention concerns the dynamic management of a database, in particular a method for dynamic management of a database and a device for its implementation.

The dynamic management according to the invention applies to a database, said data being able to be stored in storage means, such as a file manager controlling physical storage media, such as a hard drive or the like. These data are designed to be ordered through ordering means in order to permit subsequent access thereto by a user, namely the insertion of a datum, its modification or its deletion. To this end, the data, once ordered, are classified according to a structure comprising at least one field for receiving at least one datum.

It should be noted that in the following description the term <<field>> will cover any table, field or record related to a database.

The invention aims at optimizing the required memory space by ordering the data in said structure. To this end, the dynamic management of the database does not declare any structure prior to the insertion of the data. On the contrary, the space required for the declaration of the structure is allocated during the filling in of the fields of this structure at the moment when the data are introduced in said fields.

It should be noted here that this is a virtual reservation of the memory space. Indeed, the writing and the physical addressing will be performed subsequently during the recording or the saving of said database, by means of said file manager. Therefore, in this case one does not consider the physical reservation carried out by the storage means, but the declaration and the allocation of memory of the fields of the tables and of the structure of the database.

During the insertion of a datum, the characteristics of said datum permit to calculate the necessary memory space to be allocated to the field into which it is introduced. In particular, these characteristics can be its type, its format, its size, the character-string length, etc.

Therefore, dynamic management consists in optimizing the memory space required by the structure of the database by declaring a field of said structure when a datum is introduced therein. The space required for a field depends therefore on the datum itself. In addition, the structure of the database will only include fields in which a datum has been introduced. In short, the dynamic database according to the invention develops its structure and adapts its global size according to the size of the data that are introduced therein as said data are being recorded. It should be noted that data management according to the invention does not require any declaration prior to the insertion of the data.

In particular, during the insertion of a datum, means for filling in a field with said data are capable of declaring said field based on the characteristics of the datum that is introduced therein. Furthermore, the declaration of said field consists in allocating the necessary memory space on said storage means.

An advantage is based on the fact that a field that is not filled in will not be declared and no memory space will be reserved for it, in particular through the construction as the data are being introduced. Thus, the size of the enveloping structure is constantly optimized with respect to the quantity and the variety of data hosted.

The attached figures clearly show the difference of memory space reserved by a classical database in comparison with the management of a database according to the invention. In a classical database, the structure of the database, including tables, records and fields, is fixed so that, during the insertion of a datum, all fields are declared, even though they do not contain any value (grayed data). The reservation of the space at the level of the storage means is directly connected with the size of the structure. It is found that, for the same datum introduced, the structure according to the invention only includes fields the data of which include a value. Therefore, the memory space required on the storage means is thereby reduced. In addition, according to the data introduced or filled in, the structure of the database can vary and include more or less declared fields or records.

Another advantage resides in the possibility of accessing such a field that is not filled in. Indeed, the dynamic management according to the invention permits to access, through controlling means, a field when no data is introduced therein, while after all the field does not exist. To this end, said means for controlling the field verify the existence of the latter and/or the presence of a value of the datum that would be allocated to the latter. Since the field is not declared, the controlling means, instead of returning an error message, generate a reply corresponding to a field the value of the datum of which is not filled in. The dynamic management thus assumes the existence of a field that is detected as non-existent or non-declared.

In brief, the management method according to the invention considers that, virtually, any table and any field exist and that, actually, only a non-empty table is implemented.

The dynamic management also permits to temporarily declare fields of said structure. The advantage resides in that no allocation of memory has to be foreseen prior to the elaboration of a field designed for temporary use.

The dynamic management includes means for saving, on storage media, the structure and the declared fields as described above. In particular, it can save the structure on a physical medium called <<non-rewritable>> medium, such as read-only memory or ROM. To this end, the saving means permit to write all or part of the structure declared, in particular, and in the case of a modification of an existing structure, in the form of an update file of the old structure. In particular, the saving means can include a ROM burner, such as DVD, CD or the like. These update files can be incremented, i.e. several files can follow one another, the most recent file referring to the preceding file and so on until the initial file. The latter can advantageously be in the form of a recorded table, the successive increments being able to correspond to at least one instruction for insertion, deletion or any other operation performed on said table.

Another advantage resides in that the initial database can be preserved intact, the update files following one another. In this connection, it is possible to recover the state of a modified structure by deleting the most recent update file or files. Practically, one should retrieve the preceding file and record it last.

Thus, a newly created table structure will be always in the first place in an original file representing this structure, existing individually. The modification of such a structure will be carried out by means of update files, the latter containing only modifications associated with the already existing structure, and applying to the original file and/or to the preceding update file. In other words, the saving of the structure of the database consists in recording all or part of the structure, once declared, in the form of at least one original file possibly followed by at least one update file. In particular, it consists in saving all or part of the structure declared, in particular in the form of at least one original file possibly together with one or several update files.

According to a particular embodiment, the saving of a structure element will be made previously and compulsorily via an original file representing this structure element. Therefore there is no update file without said original file, the latter being able to exist without the presence of any update file. In other words, for each structure element this database is comprised of, there is one and only one original file.

An advantage resides in avoiding the saving of the whole structure of the database, thus conferring a gain of time and space by targeting the modified data only. In addition, it is then possible to modify partially a database and to preserve only the partial modifications, much less heavy in terms of memory space, and therefore more easily transportable, in particular through a removable storage medium, such as a floppy disk or a storage stick.

Finally, the dynamic management of a database according to the invention can be integrated into any type of system for management of an existing database, instead of the ordering manager, thus preserving the file manager and the user interface governing the relations between the data and the actions on the latter.

According to a preferred embodiment, the database includes a file manager capable of managing the dynamic character of the invention, only the user interface being preserved in this case, with respect to a known database system.

An advantage of the dynamic management according to the invention resides in that the structure of the database dynamically adapts to the data at the moment when they are introduced therein, economizing on the memory allocation space. The structure of the database is constructed as said data are being introduced, the enveloping structure of the data being therefore constantly optimized with respect to the quantity and the variety of the data hosted.

This invention will find its application in particular in portable apparatuses and devices the memory space of which is limited, such as cellular phones, photographic cameras, electronic agendas, etc.

The invention, of course, is not limited to the examples illustrated and described above that can have variants and undergo modifications without departing from the scope of the invention. In particular, the optimization of the memory space allocated to the structure of the database extends to the tables, to the fields and to the records of such a structure.

1. Method for dynamic management of a database, in which data, stored in storage means, are designed to be ordered through ordering means according to at least one database structure comprising at least one field for receiving at least one datum, comprising declaring, through information means, a field of said structure based on the characteristics of said datum as said data are being introduced.

2. Method for dynamic management according to claim 1, comprising calculating the memory space to be allocated to a field according to the type, size or format of the datum that is introduced therein.

3. Method for dynamic management according to claim 1, comprising accessing a non-declared field of said structure through means for controlling said field generating a reply corresponding to a declared field without any data being introduced therein.

4. Method for dynamic management according to claim 1, comprising temporarily declaring a field of said structure.

5. Method for dynamic management according to claim 1, comprising saving all or part of the structure declared in the form of at least one original file accompanied or not by at least one update file.

6. Method for dynamic management according to claim 1, comprising saving all or part of the structure declared, in particular in the form of several incremental update files.

7. Method for dynamic management according to claim 1, comprising saving the declared structure on removable and/or non-rewritable memory storage means.
